(19) United States
(12) Patent Application Publication
(10) Pub. No.: US 2026/0336537 A1
(43) Pub. Date: Oct. 29, 2026

(54) ACTIVE NOISE CONTROL METHOD USING VARIABLE CONVERGENCE FACTOR AND ACTIVE NOISE CONTROL DEVICE USING THE SAME

(71) Applicants: HYUNDAI MOBIS CO., LTD., Seoul (KR); SPb Audio Lab Bulgaria, JSC., Burgas (BG)

(72) Inventors: Dong Min Yang, Yongin-si (KR); Joo Won Park, Yongin-si (KR); Sang Jun Kim, Yongin-si (KR); Mikhail Pakhomov, Burgas (RU)

(73) Assignees: HYUNDAI MOBIS CO., LTD., Seoul (KR); SPb Audio Lab Bulgaria, JSC., Burgas (BG)

(21) Appl. No.: 19/637,522

(22) Filed: Apr. 2, 2026

(30) Foreign Application Priority Data
Apr. 24, 2025 (KR) 10-2025-0053903

(51) Int. Cl. B60R 13/08; G10K 11/178

(52) U.S. Cl. CPC B60R 13/0815; G10K 11/17823; G10K 11/17873; G10K 2210/12821; G10K 2210/3027; G10K 2210/3028; G10K 2210/501

(57) ABSTRACT

Described is an active noise control method with a variable convergence factor applied thereto including: measuring a road noise root mean square (RMS) level through each acceleration sensor included in a vehicle; setting a convergence factor value of a filter related to road noise adjustment based on the measured RMS level; storing the measured road noise RMS level and the set convergence factor value as a table; generating an RMS level-based convergence factor mathematical formula based on the stored table; and applying a variable convergence factor value calculated based on the convergence factor mathematical formula to each acceleration sensor in the vehicle.

This application claims the benefit of Korean Patent Application No. 10-2025-0053903, filed on Apr. 24, 2025, which is hereby incorporated by reference as if fully set forth herein.

### BACKGROUND OF THE DISCLOSURE

### Field of the Disclosure

The present embodiments may be applied to vehicles in all fields, and more specifically, may be applied to an active noise control method.

### Discussion of the Related Art

Vehicle manufacturers have so far made great efforts to reduce vehicle interior noise. As part of such efforts, in addition to passive schemes such as addition or improvement of a sound insulation material or a vibration damping material, an active noise control scheme for reducing noise by generating sound having a phase opposite to that of noise and overlapping the sound with noise has also been introduced.

Recently, an active road noise control (ARNC) based on such an active noise control scheme is a system for reducing noise by outputting an opposite phase signal of real-time road surface noise introduced into a microphone/reference sensor. Road surface noise, which was not highlighted by being masked by engine sound, has been highlighted with vehicle transition from internal-combustion engines to electric vehicles, and importance of ANC has increased.

In addition, by applying the ANC, a quiet indoor environment may be created without using the passive scheme such as a sound absorbing material, thereby solving a vehicle weight problem or the like.

According to the prior art, in such an ARNC technology, a convergence factor, which is one of parameters of FxLMS algorithm, affects a convergence speed and a noise reduction performance of a filter. However, to provide algorithm stability, a fixed convergence factor value optimized for an RMS level of a reference having the greatest value among several reference values is used, and thus, optimization suitable for each sensor is not able to be performed, resulting in degraded performance.

### SUMMARY OF THE DISCLOSURE

An embodiment of the present disclosure is intended to provide an active noise control method to which a variable convergence factor is applied and an active noise control device using the same.

Technical purposes to be achieved by the present disclosure are not limited to the technical purposes mentioned above, and other technical purposes not mentioned may be clearly understood by those skilled in the art to which the present disclosure pertains from the following description.

An aspect of the present disclosure for achieving the technical purposes provides: an active noise control method with a variable convergence factor applied thereto including: measuring a road noise root mean square (RMS) level through each reference sensor included in a vehicle; setting a convergence factor value of a filter related to road noise adjustment based on the measured RMS level; storing the measured road noise RMS level and the set convergence factor value as a table; generating an RMS level-based convergence factor mathematical formula based on the stored table; and applying a variable convergence factor value calculated based on the convergence factor mathematical formula to each reference sensor in the vehicle.

In one implementation, the measuring of the road noise RMS level may include measuring and storing road noise RMS levels on at least three roads in different states.

In one implementation, the generating of the convergence factor mathematical formula may include generating a convergence factor value through interpolation for RMS levels between values specified in the table.

In one implementation, the active noise control method may further include setting a minimum RMS level and a maximum RMS level.

In one implementation, the active noise control method may further include: setting the variable convergence factor value to be the same as a convergence factor value corresponding to the minimum RMS level, based on the set minimum RMS level, when a road noise RMS level equal to or lower than the minimum RMS level is input to each reference sensor; and setting the variable convergence factor value to 0, based on the set maximum RMS level, when a road noise RMS level equal to or higher than the maximum RMS level is input to each reference sensor.

According to one of the embodiments of the present disclosure, in the active noise control method, the variable convergence factor value based on the road noise level is applied rather than the fixed convergence factor value, thereby increasing the performance.

According to one of the embodiments of the present disclosure, in the active noise control method, the independent convergence factor is applied for each sensor, thereby improving the maximum performance.

Effects obtainable in the present disclosure are not limited to the effects mentioned above, and other effects not mentioned may be clearly understood by those skilled in the art to which the present disclosure pertains from the following description.

### BRIEF DESCRIPTION OF THE DRAWINGS

FIG. 1 is an overall block diagram of an autonomous driving control system to which an autonomous driving apparatus according to any one of embodiments of the present disclosure is applicable.

FIG. 2 is an exemplary diagram illustrating an example in which an autonomous driving apparatus according to any one of embodiments of the present disclosure is applied to an autonomous vehicle.

FIG. 3 is a flowchart for illustrating an active noise control method to which a variable convergence factor is applied according to an embodiment of the present disclosure.

FIG. 4 is a diagram illustrating a road RMS level measurement result according to an embodiment of the present disclosure.

FIG. 5 is a diagram illustrating a convergence factor graph according to an embodiment of the present disclosure.

FIG. 6 illustrates an active noise control device according to embodiments of the present disclosure.

### DETAILED DESCRIPTION OF THE DISCLOSURE

Hereinafter, with reference to the accompanying drawings, embodiments of the present disclosure will be described in detail so that those skilled in the art can easily practice the present disclosure. However, the present disclosure may be implemented in various different forms and is not limited to the embodiments described herein. In addition, in the drawings, in order to clearly explain the present disclosure, parts that are not related to the description will be omitted, and the same or similar parts are denoted by the same reference numerals throughout the description.

Throughout the description, when a part is referred to as “including” an element, it may not mean that the part excludes other elements, but may mean that the part includes other elements, unless stated otherwise.

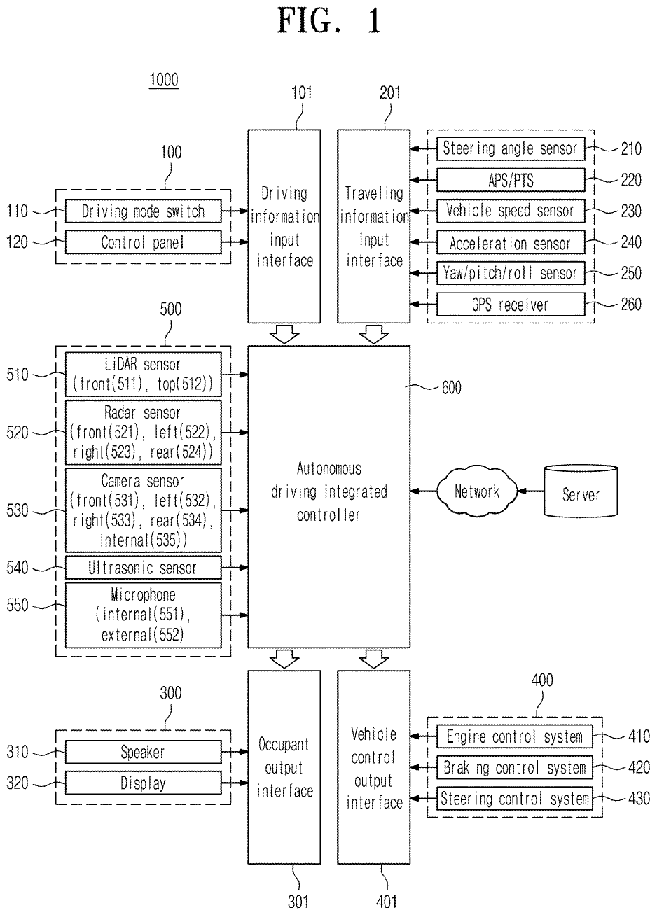

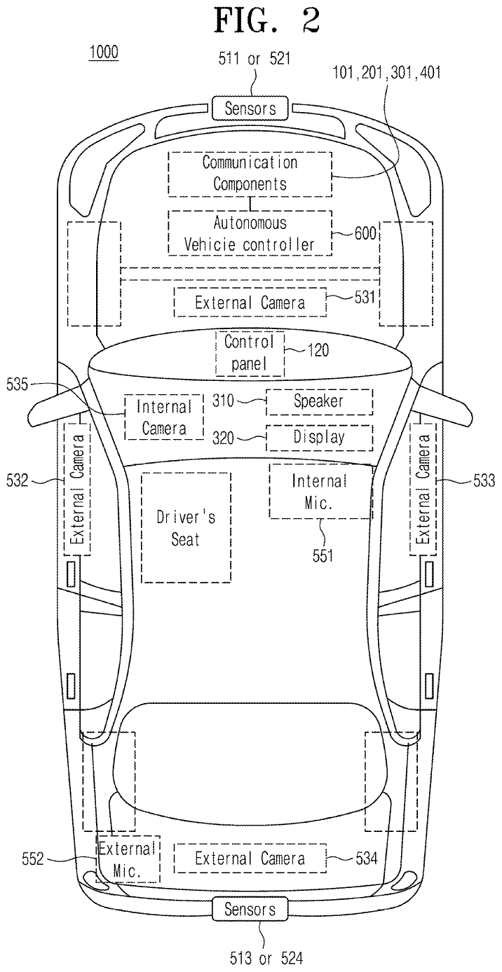

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

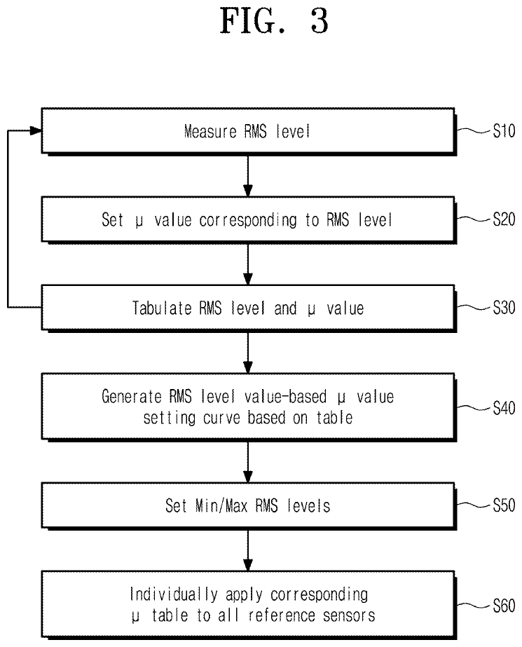

FIG. 3 is a flowchart for illustrating an active noise control method to which a variable convergence factor is applied according to an embodiment of the present disclosure.

An embodiment of the present disclosure aims to improve system stability for divergence by monitoring an input signal of active road noise control and characterizing the input signal, sensing a type and a state of a road surface, and controlling a state of a filter.

In an active noise control system with high dependence on the input signal, an embodiment of the present disclosure aims to implement a more active and stable adaptive system for an unstable input signal that may occur while traveling of a vehicle.

The active noise control system utilizes, for example, a Feed-forward FxLMS structure to adaptively remove undesirable noise in a listening environment. The corresponding structure updates a filter coefficient of an adaptive logic using the input signal, so that validity of the input signal has a great influence on system performance.

The convergence factor μ, which is one of parameters of the FxLMS algorithm used in such an active noise control technology, affects a convergence speed and a noise reduction performance of the filter.

A mathematical formula for updating the filter of the ANC algorithm for the vehicle is as illustrated in Mathematical Formula 1 below.

[Mathematical Formula 1]

Wₙ₊₁Wₙ+(μ)ex

Here, W denotes a filter coefficient, μ denotes the convergence factor, e denotes a residual error, and x denotes a reference signal (input).

In this regard, in a state in which the convergence factor (μ) is fixed, values of e and x may be received in real time to update the W value, which is the filter coefficient.

Therefore, because the filter coefficient value of the system changes based on roughness of the road surface, a technology for calculating the filter coefficient in real time in response to the roughness of the road surface is required.

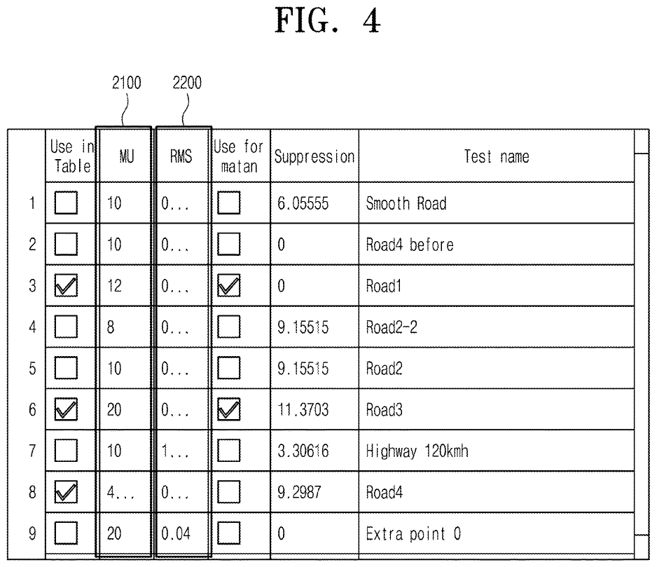

According to a process illustrated in FIG. 4, by monitoring the input signal, the active noise control may be performed by generating the convergence factor based on a road surface type, and by automatically updating the state of the filter based on the monitored value, safety may be secured and performance may be maintained.

First, as illustrated in FIG. 4, a vehicle according to an embodiment of the present disclosure measures a road noise root mean square (RMS) level (S10). Specifically, to measure noise of a test road, the vehicle installed with a reference sensor may perform test travel and measure the road noise RMS level. Here, the reference sensor may be, for example, a reference sensor.

Furthermore, the vehicle according to an embodiment of the present disclosure sets a convergence factor (μ) value corresponding to the RMS level (S20). To this end, for example, a suitable convergence factor (μ) value exhibiting maximum performance on a test road may be set.

In addition, the vehicle according to an embodiment of the present disclosure tabulates the road noise RMS level and the convergence factor (μ) value (S30). For example, convergence factor (μ) values may be set and tabulated by measuring road noise RMS levels at at least three test roads (rough road, normal road, and smooth road), respectively.

In addition, the vehicle according to an embodiment of the present disclosure generates a road noise RMS level value-based convergence factor (μ) value setting curve based on the table (S40).

Thereafter, the vehicle according to an embodiment of the present disclosure sets minimum and maximum RMS levels (S50). For example, when the minimum RMS level is set, when a value equal to or lower than the minimum RMS level is input to the reference sensor through the minimum RMS level setting, the vehicle may maintain the convergence factor (μ) value at a value corresponding to the minimum RMS level, thereby preventing the convergence factor (μ) value from abnormally increasing.

For example, when the maximum RMS level is set, the vehicle may set the convergence factor (μ) value to 0 when the RMS level exceeds the maximum RMS level, and may set the filter not to be updated with respect to an abnormal input or a single-shot impact signal generated during the traveling, thereby preventing the divergence.

Finally, the vehicle according to an embodiment of the present disclosure individually applies the convergence factor (μ) table to all reference sensors (S60). Specifically, the vehicle may apply the convergence factor (μ) table to each sensor on an individual basis. Accordingly, because different convergence factor values are applied to the respective sensors when the vehicle travels on the road, there is an advantage in that a performance contribution of each sensor may be improved and the stability may be secured.

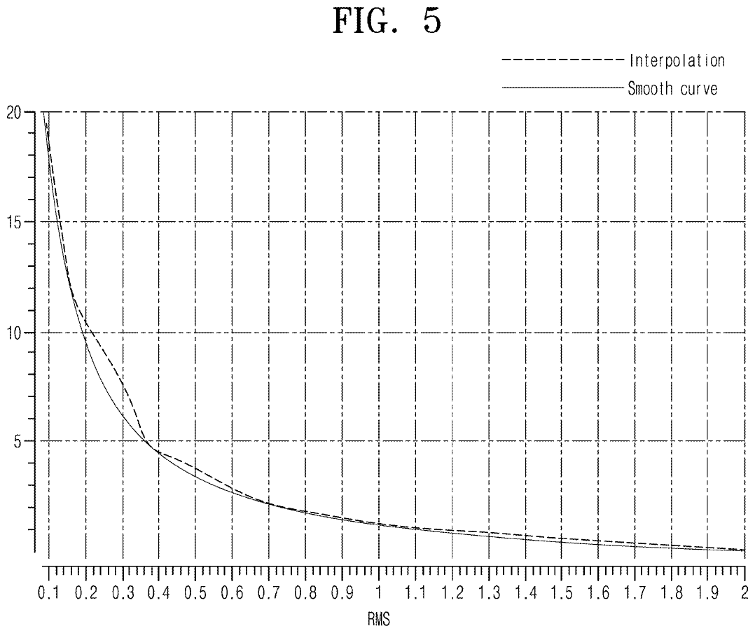

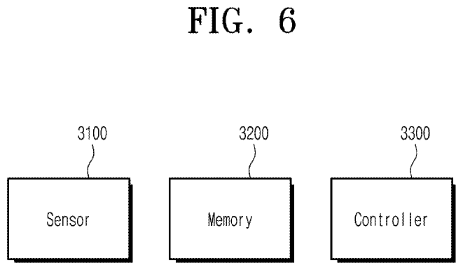

FIG. 5 illustrates a convergence factor value table based on a road noise RMS level according to an embodiment of the present disclosure. FIG. 6 illustrates a convergence factor graph according to an embodiment of the present disclosure.

Because the actual road surface on which the vehicle travels is not uniform, various vibrations are generated in the vehicle due to influence of the non-uniform road or the like. Because the active road noise reduction system aims to reduce road surface noise and uses road surface vibration as an input to the system, road surface noise is the most influential factor.

Therefore, it is important to design the filter that accurately senses the generated vibration and generates an output having a phase opposite to that of the vibration.

However, according to the related art, in sensor normalization, the RMS level of the reference having the greatest value among the several reference values is set as a master reference sensor (Master Acc) to provide algorithm stability on the roughest road surface. The fixed convergence factor (μ) value optimized for the RMS level of the set master reference sensor (Master Acc) is used to prevent divergence of the algorithm on the rough road surface. In addition, remaining reference sensors having low signal levels except for the master reference sensor (Master Acc) increase their contribution to the performance through the sensor normalization.

However, because the remaining sensors are basically normalized based on the master reference sensor (Master Acc) in the sensor normalization, optimization based on the signal levels of the remaining sensors may not be performed, so that an individualized convergence factor (μ) value suitable for each sensor signal level should be applied instead of the normalization in order to secure a higher performance contribution of each sensor.

To this end, the vehicle according to the present disclosure may generate the convergence factor value table based on the road noise RMS level.

As illustrated in FIG. 5, the vehicle may travel on a plurality of test roads in a non-uniform state, and may measure an MU 2100, which is a convergence factor (μ) value at each of the plurality of test roads, and an RMS level 2200 for each road. In addition, the vehicle may set respective convergence factor (μ) values exhibiting maximum active road noise performances on the plurality of test roads. Accordingly, the vehicle may set an optimal convergence factor (μ) value based on the RMS level 2200 for each road.

Thereafter, the vehicle may generate a table based on the convergence factor values based on the road noise RMS levels of the plurality of test roads. The table thus generated may be used in a tuning process of the vehicle.

As illustrated in FIG. 6, the vehicle may generate a convergence factor mathematical formula based on the RMS value based on the table generated during the tuning process.

The vehicle may generate a convergence factor (μ) value through interpolation for road noise RMS levels between values specified in the table.

In one example, the vehicle may generate the convergence factor (μ) value based on the road noise RMS level using a smooth curve mathematical formula.

Accordingly, the vehicle may generate the convergence factor mathematical formula based on the table generated in the tuning step. The vehicle may update an optimal filter coefficient for the ANC algorithm filter by applying the generated convergence factor mathematical formula.

For example, the vehicle may generate values corresponding to all inputs of the ANC algorithm filter through three RMS-to-convergence factor (μ) values.

Accordingly, the vehicle has an advantage of improving the active noise control performance by applying the variable convergence factor value based on the road noise level rather than the fixed convergence factor (μ) value.

In one example, the method invention illustrated in FIG. 3 may be implemented as a product invention by those skilled in the art with reference to FIG. 6.

A sensor 3100 senses the input signal based on the state of the road through the reference sensor. Specifically, the input signal based on the state of the road may be the road noise RMS level.

A memory 3200 may store the RMS level 2200 for each road measured from each of the plurality of test roads while the vehicle travels on the plurality of test roads in the non-uniform state, and store the optimal convergence factor (μ) value 2200 based on the RMS level 2200 for each road.

For example, the memory 3200 may store the road noise RMS levels from at least three roads in different states.

In addition, the memory 3200 may store the table generated based on the RMS level for each road and the convergence factor (μ) value.

A controller 3300 may set the convergence factor value of the filter related to road noise adjustment based on the measured RMS level.

The controller 3300 may store the measured road noise RMS level and the set convergence factor value as the table.

The controller 3300 may generate the convergence factor mathematical formula based on the RMS level based on the stored table.

For example, the controller 3300 may generate the convergence factor value through the interpolation for the RMS levels between the values specified in the table.

For example, the controller 3300 may generate the convergence factor value based on the RMS level using the smooth curve mathematical formula.

The controller 3300 may set the minimum RMS level and the maximum RMS level.

Based on the set minimum RMS level, when the road noise RMS level equal to or lower than the minimum RMS level is input to the reference sensor, the controller 3300 may set the variable convergence factor value to be the same as the convergence factor value corresponding to the minimum RMS level.

Based on the set maximum RMS level, when the road noise RMS level equal to or higher than the maximum RMS level is input to the reference sensor, the controller 3300 may set the variable convergence factor value to 0.

The controller 3300 may individually apply the variable convergence factor value calculated based on the convergence factor mathematical formula for each reference sensor in the vehicle.

That is, the technical idea of the present disclosure may be applied to an entire autonomous vehicle or may be applied to only some components inside the autonomous vehicle. The scope of the present disclosure should be determined based on matters described in the claims.

As another aspect of the present disclosure, the above-described proposal or operation of the present disclosure may be provided as a code that may be implemented, realized, or executed by a “computer” (a comprehensive concept including a system on chip (SoC), a microprocessor, or the like), or an application, a computer-readable storage medium, a computer program product, or the like that stores or contains the code, which also falls within the scope of the present disclosure.

A detailed description of the preferred embodiments of the present disclosure disclosed as described above has been provided for those skilled in the art to implement and realize the present disclosure. Although the description has been made with reference to the preferred embodiments of the present disclosure, those skilled in the art will understand that the present disclosure may be variously modified and changed without departing from the scope of the present disclosure. For example, those skilled in the art may use each of the components described in the above-described embodiments in a manner of combining them with each other.

Accordingly, the present disclosure is not intended to be limited to the embodiments illustrated herein, but to be accorded the broadest scope consistent with the principles and novel features disclosed herein.

What is claimed is:

1. An active noise control method with a variable convergence factor applied thereto, the active noise control method comprising:
measuring a road noise root mean square (RMS) level through each acceleration sensor included in a vehicle;
setting a convergence factor value of a filter related to road noise adjustment based on the measured RMS level;
storing the measured road noise RMS level and the set convergence factor value as a table;
generating an RMS level-based convergence factor mathematical formula based on the stored table; and
control a vehicle interior noise by applying a variable convergence factor value calculated based on the convergence factor mathematical formula to each acceleration sensor in the vehicle.

2. The active noise control method of claim 1, wherein the measuring of the road noise RMS level includes measuring and storing road noise RMS levels on at least three roads in different states.

3. The active noise control method of claim 2, wherein the generating of the convergence factor mathematical formula includes generating a convergence factor value through interpolation for RMS levels between values specified in the table.

4. The active noise control method of claim 3, further comprising setting a minimum RMS level and a maximum RMS level.

5. The active noise control method of claim 4, further comprising:
setting the variable convergence factor value to be the same as a convergence factor value corresponding to the minimum RMS level, based on the set minimum RMS level, when a road noise RMS level equal to or lower than the minimum RMS level is input to each acceleration sensor; and
setting the variable convergence factor value to 0, based on the set maximum RMS level, when a road noise RMS level equal to or higher than the maximum RMS level is input to each acceleration sensor.

6. An active noise control device comprising:
each acceleration sensor configured to measure a road noise root mean square (RMS) level; and
a controller configured to:
set a convergence factor value of a filter related to road noise adjustment based on the measured RMS level;
store the measured road noise RMS level and the set convergence factor value as a table in a memory;
generate an RMS level-based convergence factor mathematical formula based on the stored table; and
control a vehicle interior noise by applying a variable convergence factor value calculated based on the convergence factor mathematical formula to each acceleration sensor in a vehicle.

7. The active noise control device of claim 6, wherein the memory is configured to measure and store road noise RMS levels on at least three roads in different states.

8. The active noise control device of claim 7, wherein the controller is configured to generate a convergence factor value through interpolation for RMS levels between values specified in the table.

9. The active noise control device of claim 8, wherein the controller is configured to set a minimum RMS level and a maximum RMS level.

10. The active noise control device of claim 9, wherein the controller is configured to:
set the variable convergence factor value to be the same as a convergence factor value corresponding to the minimum RMS level, based on the set minimum RMS level, when a road noise RMS level equal to or lower than the minimum RMS level is input to each acceleration sensor; and
set the variable convergence factor value to 0, based on the set maximum RMS level, when a road noise RMS level equal to or higher than the maximum RMS level is input to each acceleration sensor.
